(19) United States
(12) Patent Application Publication
(10) Pub. No.: US 2022/0134805 A1
(43) Pub. Date: May 5, 2022

(54) Vehicle Tire Comprising a Stiffening Structure

(71) Applicant: COMPAGNIE GENERALE DES ETABLISSEMENTS MICHELIN, Clermont-Ferrand (FR)

(72) Inventors: Frederic PERRIN, Clermont-Ferrand Cedex 9 (FR); Florian LACHAL, Clermont-Ferrand Cedex 9 (FR); Gaël PATAUT, Clermont-Ferrand Cedex 9 (FR); Richard CORNILLE, Clermont-Ferrand Cedex 9 (FR); Olivier REIX, Clermont-Ferrand Cedex 9 (FR)

(21) Appl. No.: 17/416,047

(22) PCT Filed: Dec. 11, 2019
(86) PCT No.: PCT/FR2019/053022

§ 371 Date: Jun. 18, 2021

(30) Foreign Application Priority Data
Dec. 19, 2018 (FR) 1873322
Feb. 4, 2019 (FR) 1901038

(51) Int. Cl. B60C 9/20; B60C 9/00

(52) U.S. Cl. CPC B60C 9/2006; B60C 11/0311; B60C 9/0007; B60C 9/20

(57) ABSTRACT

A tire (1) for an agricultural vehicle, having a crown reinforcement (3), with at least two crown layers (31, 32), each having metal reinforcers which are coated in an elastomer material. Any metal reinforcer of a crown layer (31, 32) has a law, known as a bi-modulus law, governing its elastic behaviour under tension, comprising a first portion having a first extension modulus MG1 at most equal to 30 GPa, and a second portion having a second extension modulus MG2 at least equal to 2 times the first extension modulus MG1, and any metal reinforcer of a crown layer (31, 32) has a law governing its behaviour under compression that is characterized by a critical buckling strain EU at least equal to 3%.

The present invention relates to a tire for an agricultural vehicle, such as an agricultural tractor or an agri-industrial vehicle, and relates more particularly to the crown reinforcement thereof.

The dimensional specifications and conditions of use (load, speed, pressure) of a tire for an agricultural vehicle are defined in standards, such as, for example, the ETRTO (European Tire and Rim Technical Organisation) standard. By way of example, a radial tire for a driven wheel of an agricultural tractor is intended to be mounted on a rim of which the diameter is generally comprised between 16 inches and 46 inches, or even 54 inches. It is intended to be run on an agricultural tractor of which the power is comprised between 50 CV and more than 250 CV (up to 550 CV) and able to run at up to 65 km/h. For this type of tire, the minimum recommended inflation pressure corresponding to the indicated loading capacity is usually at most equal to 400 kPa, but may drop as low as 240 kPa for an IF (Improved Flexion) tire, or even 160 kPa for a VF (Very high Flexion) tire.

Like any tire, a tire for an agricultural vehicle comprises a tread intended to come into contact with the ground via a tread surface, the two axial ends of which are connected via two sidewalls to two beads that provide the mechanical connection between the tire and the rim on which it is intended to be mounted.

In the following text, the circumferential, axial and radial directions refer to a direction tangential to the tread surface and oriented in the direction of rotation of the tire, to a direction parallel to the axis of rotation of the tire, and to a direction perpendicular to the axis of rotation of the tire, respectively.

A radial tire for an agricultural vehicle comprises a reinforcement made up of a crown reinforcement radially on the inside of the tread and of a carcass reinforcement radially on the inside of the crown reinforcement.

The tread of a tire for an agricultural vehicle generally comprises a plurality of raised elements, known as tread block elements, extending radially outward from a bearing surface as far as the tread surface, and usually separated from one another by voids or grooves. These tread block elements are usually lugs, generally of overall parallelepipedal elongate shape, comprising at least one rectilinear or curvilinear portion.

The carcass reinforcement of a radial tire for an agricultural vehicle comprises at least one carcass layer connecting the two beads to one another. A carcass layer comprises reinforcers coated in a polymer material containing an elastomer, obtained by blending, or elastomer compound. The carcass layer reinforcers are usually made up of textile polymer materials, such as a polyester, for example a polyethylene terephthalate (PET), an aliphatic polyamide, for example a nylon, an aromatic polyamide, for example aramid, or else rayon. The reinforcers of a carcass layer are substantially mutually parallel and form an angle comprised between 85° and 95° with the circumferential direction.

The crown reinforcement of a radial tire for an agricultural vehicle comprises a superposition of circumferentially extending crown layers, radially on the outside of the carcass reinforcement. Each crown layer is made up of reinforcers which are coated in an elastomer compound and mutually parallel. When the crown layer reinforcers form, with the circumferential direction, an angle at most equal to 10°, they are referred to as circumferential, or substantially circumferential, and perform a hooping function that limits the radial deformations of the tire. When the crown layer reinforcers form, with the circumferential direction, an angle at least equal to 10° and usually at most equal to 40°, they are referred to as angled reinforcers, and have a function of reacting the transverse loads, parallel to the axial direction, that are applied to the tire. The crown layer reinforcers may be made up of textile polymer materials, such as a polyester, for example a polyethylene terephthalate (PET), an aliphatic polyamide, for example a nylon, an aromatic polyamide, for example aramid, or else rayon, or may be made up of metallic materials such as steel.

A tire for an agricultural vehicle is intended to run over various types of ground such as the more or less compact soil of the fields, unmade tracks providing access to the fields, and the tarmacked surfaces of roads. Bearing in mind the diversity of use, in the field and on the road, a tire for an agricultural vehicle needs to offer a performance compromise between traction in the field on loose ground, resistance to chunking, resistance to wear on the road, resistance to forward travel, and vibrational comfort on the road, this list not being exhaustive.

One essential problem in the use of a tire in the field is that of limiting, as far as possible, the extent to which the soil is compacted by the tire, as this is liable to hamper crop growth. This is why, in the field of agriculture, low-pressure and therefore high-flexion, tires have been developed. The ETRTO standard thus makes a distinction between IF (Improved Flexion) tires, which have a minimum recommended inflation pressure generally equal to 240 kPa, and VF (Very high Flexion) tires, which have a minimum recommended inflation pressure generally equal to 160 kPa. According to that standard, by comparison with a standard tire, an IF tire has a 20% higher load-bearing capability and a VF tire has a 40% higher load-bearing capability, for an inflation pressure equal to 160 kPa.

However, the use of low-pressure tires has had a negative impact on the handling in the field. Thus, the lowering of the inflation pressure has led to a reduction in the transverse and cornering stiffnesses of the tire, thus reducing the transverse thrust of the tire and therefore resulting in inferior handling under transverse loads. One solution for re-establishing the correct transverse thrust has been to stiffen the crown reinforcement of the tire transversely, by replacing the crown layers having textile reinforcers with crown layers having metal reinforcers. Thus, for example, a crown reinforcement comprising six crown layers with textile reinforcers of the rayon type has been replaced with a crown reinforcement comprising two crown layers with metal reinforcers made of steel. Document EP 2934917 thus describes an IF tire comprising a crown reinforcement comprising at least two crown layers having metal reinforcers, which is combined with a carcass reinforcement comprising at least two carcass layers having textile reinforcers.

However, the use of crown layers having metal reinforcers, in a tire for an agricultural vehicle, may lead to a reduction in the endurance of the crown of the tire, as a result of premature breakage of the metal reinforcers.

The inventors have therefore set themselves the objective of increasing the endurance of a crown reinforcement with metal reinforcers that are to a level at least equivalent to that of a crown reinforcement with textile reinforcers, particularly for a tire for an agricultural vehicle operating at low pressure, such as an IF (Improved Flexion) tire or a VF (Very high Flexion) tire.

This objective has been achieved, according to the invention, by a tire for an agricultural vehicle, comprising a crown reinforcement radially on the inside of a tread and radially on the outside of a carcass reinforcement,
the crown reinforcement comprising at least two crown layers each comprising metal reinforcers which are coated in an elastomeric material, are mutually parallel and form an angle A at least equal to 10° with a circumferential direction,
any metal reinforcer of a crown layer having a law, known as a bi-modulus law, governing its elastic behaviour under tension, and comprising a first portion having a first extension modulus MG1 at most equal to 30 GPa, and a second portion having a second extension modulus MG2 at least equal to 2 times the first extension modulus MG1, said law governing the tensile behaviour being determined for a metal reinforcer coated in an elastomer compound having a tensile elastic modulus at 10% elongation, MA10, at least equal to 5 MPa and at most equal to 15 MPa,
and any metal reinforcer of a crown layer having a law governing its behaviour under compression that is characterized by a critical buckling strain E0 at least equal to 3%, said law governing behaviour under compression being determined on a test specimen made up of a reinforcer placed at its centre and coated with a parallelepipedal volume of an elastomer compound having a tensile elastic modulus at 10% elongation, MA10, at least equal to 5 MPa and at most equal to 15 MPa.

For a tire for an agricultural vehicle, comprising a crown reinforcement having at least two crown layers with metal reinforcers, the inventors propose to use elastic metal reinforcers of which the laws governing their behaviour have specific characteristics both in tension and in compression.

As regards its behaviour under tension, a bare metal reinforcer, which is to say one not coated with an elastomer material, is mechanically characterized by a curve representing the tensile force (in N) applied to the metal reinforcer as a function of the relative elongation (% strain) thereof, known as the force-elongation curve. Mechanical extensile characteristics of the metal reinforcer, such as the structural elongation As (in %), the total elongation at break At (in %), the force at break Fm (maximum load in N) and the breaking strength Rm (in MPa) are derived from this force-elongation curve, these characteristics being measured, for example, in accordance with the standard ISO 6892 of 1984, or the standard ASTM D2969-04 of 2014.

The total elongation at break At of the metal reinforcer is, by definition, the sum of the structural, elastic and plastic elongations thereof (At=As+Ae+Ap). The structural elongation As results from the relative positioning of the metallic threads making up the metallic reinforcer under a low tensile force. The elastic elongation Ae results from the actual elasticity of the metal of the metallic threads making up the metallic reinforcer, taken individually, the behaviour of the metal following Hooke's law. The plastic elongation Ap results from the plasticity, i.e. the irreversible deformation of the metal of these metal threads taken individually, beyond the elastic limit.

In the context of the invention, the law governing the tensile behaviour of a metal reinforcer is determined for a metal reinforcer coated in a cured elastomer material, corresponding to a metal reinforcer extracted from the tire, on the basis of the standard ISO 6892 of 1984, as for a bare metal reinforcer. By way of example, and nonlimitingly, a cured elastomer coating material is a rubber-based composition having a secant extension elastic modulus at 10% elongation, MA10, at least equal to 5 MPa and at most equal to 15 MPa, for example equal to 6 MPa. This tensile elastic modulus is determined from tensile testing performed in accordance with French Standard NF T 46-002 of September 1988.

From the force-elongation curve, for a bi-modulus elastic behaviour law comprising a first portion and a second portion, it is possible to define a first tensile stiffness KG1 representing the gradient of the secant straight line passing through the origin of the frame of reference in which the behaviour law is represented, and the transition point marking the transition between the first and second portions. Likewise, it is possible to define a second tensile stiffness KG2 representing the gradient of a straight line passing through two points positioned in a substantially linear part of the second portion.

From the force-elongation curve that characterizes the tensile behaviour of a reinforcer, it is also possible to define a stress-strain curve, the stress being equal to the ratio between the tensile force applied to the reinforcer and the cross-sectional area of the reinforcer, and the strain being the relative elongation of the reinforcer. For a bi-modulus elastic behaviour law comprising a first portion and a second portion, it is possible to define a first extension modulus MG1 representing the gradient of the secant straight line passing through the origin of the frame of reference in which the behaviour law is represented, and the transition point marking the transition between the first and second portions. Likewise, it is possible to define a second extension modulus MG2 representing the gradient of a straight line passing through two points positioned in a substantially linear part of the second portion. The tensile stiffnesses KG1 and KG2 are respectively equal to MG1*S and MG2*S, S being the cross-sectional area of the reinforcer. It should be noted that the bi-modulus behaviour laws involved in the context of the invention comprise a first portion with a low modulus and a second portion with a high modulus.

According to the invention, regarding the tensile behaviour of the metal reinforcers, any metal reinforcer of a crown layer has a law, known as a bi-modulus law, governing its elastic behaviour under tension, comprising a first portion having a first extension modulus MG1 at most equal to 30 GPa, and a second portion having a second extension modulus MG2 at least equal to 2 times the first extension modulus MG1.

As regards the behaviour under compression, a metal reinforcer is mechanically characterized by a curve representing the compression force (in N) applied to the metal reinforcer as a function of the compression strain thereof (in %). Such a compression curve is particularly characterized by a limit point, defined by a critical buckling force Fc, and a critical buckling strain E0, beyond which the reinforcer experiences compressive buckling, corresponding to a state of mechanical instability characterized by large amounts of deformation of the reinforcer with a reduction in the compressive force.

The law governing the behaviour in compression is determined, using a test machine of the Zwick or Instron type, on a test specimen measuring 12 mm×21 mm×8 mm (width×height×thickness). The test specimen consists of a reinforcer placed at its centre and coated with a parallelepipedal volume of an elastomer compound defining the volume of the test specimen, the axis of the reinforcer being positioned along the height of the test specimen. In the context of the invention, the elastomer compound of the test specimen has a secant extension elastic modulus at 10% elongation, MA10, at least equal to 5 MPa and at most equal to 15 MPa, for example equal to 6 MPa. The test specimen is compressed in the heightwise direction, at a rate of 3 mm/min until compressive deformation is achieved, namely until the test specimen is compressed by an amount equal to 10% of its initial height, at ambient temperature. The critical buckling force Fc and the corresponding critical buckling strain E0 are reached when the applied force decreases while the strain continues to increase. In other words, the critical buckling force Fc corresponds to the maximum compression force Fmax.

According to the invention, regarding the compressive behaviour of the metal reinforcers, any metal reinforcer of a crown layer has a law governing its behaviour under compression that is characterized by a critical buckling strain E0 at least equal to 3%.

The inventors have demonstrated that metal reinforcers referred to as being elastic, characterized by laws as described hereinabove governing their behaviour under tension and under compression, have a fatigue endurance limit, during repeated alternating cycles of tensile/compressive loadings, that is higher than that of the usual metal reinforcers.

Specifically, when a tire for an agricultural vehicle, comprising a lugged tread is being driven on, the tilting of the lugs under (driving or braking) torque causes the crown layers positioned radially on the inside of the lugs to tilt. This tilting leads to curvatures, which alternate between positive and negative, of the crown layers, and correspondingly to alternating cycles of compressive/tensile loadings of the metal reinforcers of the crown layers.

It should also be noted that the crown layers of a tire for an agricultural vehicle often have initial curvatures, both in the circumferential direction and in the axial direction, as a result of the movements of the various elastomeric components and of the reinforcers during the course of manufacture, as the tire is being moulded and cured. These initial deformations combine with the deformations resulting from the tilting of the lugs and therefore likewise contribute to the cyclic compressive/tensile loadings of the metal reinforcers of the crown layers as the tire is being driven on.

Thus, crown layer elastic metal reinforcers according to the invention are better able to withstand the above-mentioned cyclic compressive/tensile loadings, leading to an improvement in the endurance of the crown reinforcement of the tire and therefore to a lengthening of the life of the tire.

Advantageously, in instances in which the crown reinforcement is made up of two crown layers, the linear density of a metal reinforcer of a crown layer is at least equal to 6 g/m and at most equal to 13 g/m. The linear density of the metal reinforcer is the mass of metal of a portion of reinforcer having a unit length equal to 1 m. The linear density is correlated with the extension modulus of the reinforcer, and therefore with its stiffness. Therefore, this range of linear-density values has been considered to be optimal with regards to the target stiffness for the reinforcer. More generally, for a crown reinforcement made up of 2n crown layers, the linear density of the reinforcers that make up each crown layer is advantageously at least equal to 6/n g/m and at most equal to 13/n g/m.

According to a preferred embodiment of the metal reinforcers, any metal reinforcer of a crown layer is a multistrand rope of structure 1×N comprising a single layer of N strands of diameter DT wound in a helix at an angle AT and a radius of curvature RT, each strand comprising an internal layer of M internal threads wound in a helix and an external layer of P external threads wound in a helix around the internal layer. This is a type of metal reinforcer commonly used in the field of tires.

Usually, all the strands have the same diameter DT. Each strand is wound in a helix about the axis of the cord, this helix being characterized by a helix pitch PT, a helix angle AT and a radius of curvature RT. The helix pitch PT is the distance after which the strand has made a full turn of the helix. The radius of curvature RT is calculated using the relationship RT=PT/(π*Sin(2*AT)).

In the particular case in which the crown-layer metal reinforcers are multistrand ropes, the helix angle AT of a strand is advantageously at least equal to 20° and at most equal to 30°. This range of values for the helix angle AT of a strand governs the geometry of the cord and, in particular, the curvature of the strand which has an impact on the level of critical buckling strain E0 and contributes to obtaining a value at least equal to 3%.

Again in the particular case in which the crown-layer metal reinforcers are multistrand ropes, the ratio RT/DT between the radius of curvature of the helix of a strand RT, and the diameter of a strand DT, is also advantageously at most equal to 5. This maximum value for the ratio RT/DT is a criterion that also contributes to a level of critical buckling strain E0 at least equal to 3%.

In instances in which the crown reinforcement is made up of two crown layers and in which the crown layer metal reinforcers are multistrand ropes, the diameter D of a metal reinforcer of a crown layer is more advantageously still at least equal to 1.4 mm and at most equal to 3 mm This range of values for the diameter D is compatible with the range of values targeted for the linear density of the reinforcer. Such reinforcers are obtained from an assembly of steel threads generally having a diameter at most equal to 0.35 mm, or even at most equal to 0.28 mm.

Again in instances in which the crown reinforcement is made up of two crown layers, the breaking strength R of a crown layer is at least equal to 500 N/mm and at most equal to 1500 N/mm The breaking strength R of a crown layer is equal to the individual braking force, in N, of a metal reinforcer divided by the pitch spacing, in mm, namely the distance between two consecutive reinforcers. The breaking strength R governs, in particular, the resistance to bursting of a tire under pressure, with a given factor of safety.

According to one advantageous embodiment of the crown reinforcement, the crown reinforcement comprises at least one hooping layer comprising reinforcers which are coated in an elastomeric material, are mutually parallel and form an angle B at most equal to 10° with the circumferential direction (XX′). A hooping layer has the function of contributing to absorbing the mechanical inflation stresses, and also to improving the endurance of the crown reinforcement by stiffening same, when the tire is compressed under a radial load and, in particular, subjected to a cornering angle about the radial direction. Among the hooping layers, a distinction is made between the hooping layers known as closed-angle hooping layers, that is to say in which the reinforcers form angles at least equal to 5° and at most equal to 10° with the circumferential direction, and the circumferential, more specifically substantially circumferential, hooping layers, that is to say ones in which the reinforcers form angles at most equal to 5°, and possibly zero, with the circumferential direction. The closed-angle hooping layers comprise reinforcers having free ends at the axial ends of the hooping layers. The circumferential hooping layers comprise reinforcers that do not have free ends at the axial ends of the hooping layers, since the circumferential hooping layers are usually obtained by circumferentially winding a ply of reinforcers or by circumferentially winding a reinforcer. The reinforcers of a hooping layer may be either continuous, or fractionated. The reinforcers of a hooping layer may be either metal or textile.

According to another advantageous embodiment of the crown reinforcement, the crown reinforcement comprises at least one additional crown layer comprising metal reinforcers which are coated in an elastomeric material, are mutually parallel and form an angle C at least equal to 60° and at most equal to 90° with the circumferential direction. This additional crown layer comprises metal reinforcers, which are not necessarily elastic and are not necessarily of the type of those of the invention and which form angles comprised between 60° and 90° with respect to the circumferential direction. These angles are higher than those formed by the elastic reinforcers of the crown layers according to the invention, generally comprised between 10° and 40°. This additional crown layer, positioned radially either on the inside or on the outside of the crown layers according to the invention, and usually being decoupled from said layers, namely separated from them by a layer of elastomer compound, contributes to the stiffening of the crown reinforcement through a hooping effect by triangulation with the other crown layers.

Usually, the carcass reinforcement comprises at least one carcass layer comprising textile reinforcers that are coated in an elastomeric material, are mutually parallel and form an angle D at least equal to 85° and at most equal to 95° with the circumferential direction. However, a smaller angle D, typically at least equal to 65°, is also conceivable.

According to one usual embodiment of the tread, the tread is made up of a first and a second row of lugs extending radially outwards from a bearing surface and disposed in a chevron pattern with respect to the equatorial plane of the tire.

The invention applies in particular to a radial tire for a driven wheel of an agricultural tractor and, more particularly still, to an IF (Improved Flexion) tire, which has a minimum recommended inflation pressure generally equal to 240 kPa, and a VF (Very high Flexion), tire, which has a minimum recommended inflation pressure generally equal to 160 kPa. It may even be extended to a tire inflated to a low pressure, as recommended for a VF tire, but having a load-bearing capacity greater than that of a VF tire.

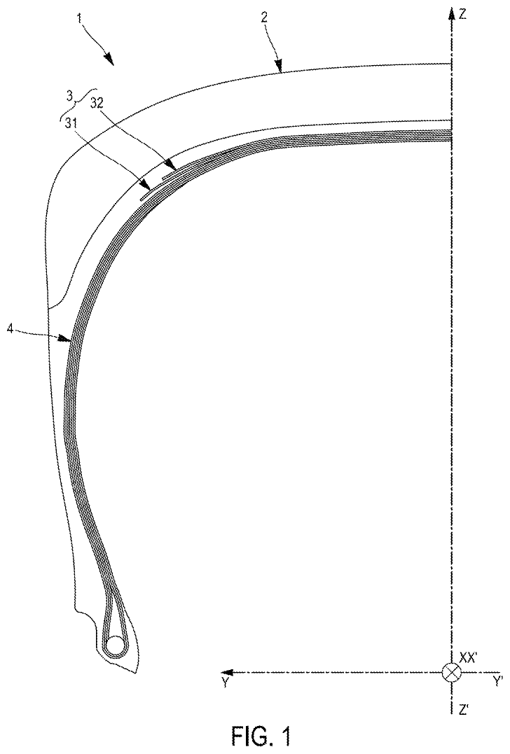

The features of the invention are illustrated by the schematic FIGS. 1 to 7, which are not drawn to scale:

FIG. 1: Meridian half-section of a tire for an agricultural vehicle according to the invention

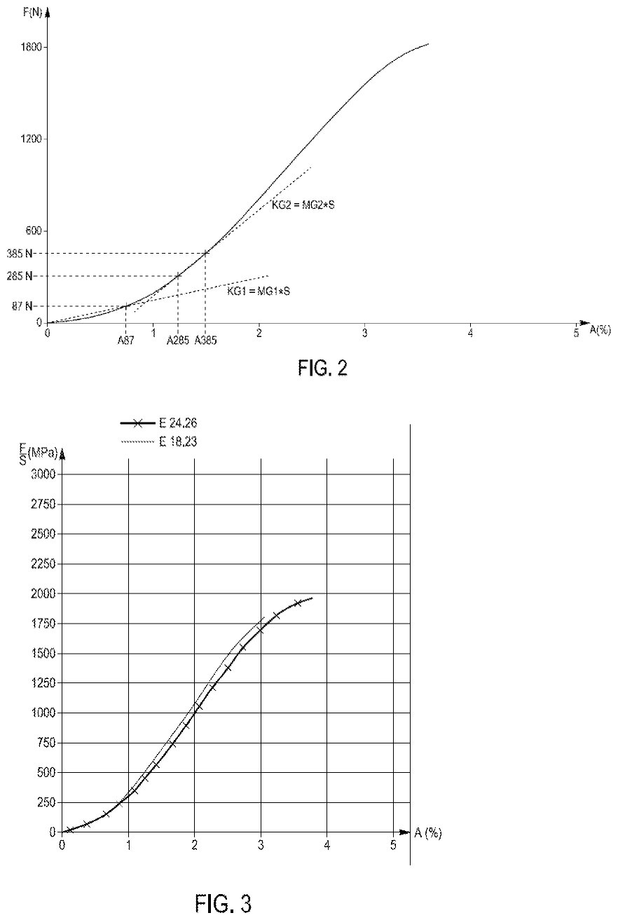

FIG. 2: Typical example of a typical tensile force-elongation curve for an elastic metal reinforcer according to the invention, coated with an elastomeric material

FIG. 3: Tensile stress-elongation curves for two particular examples of elastic metal reinforcer according to the invention (E12.23 and E24.26) coated with an elastomeric material

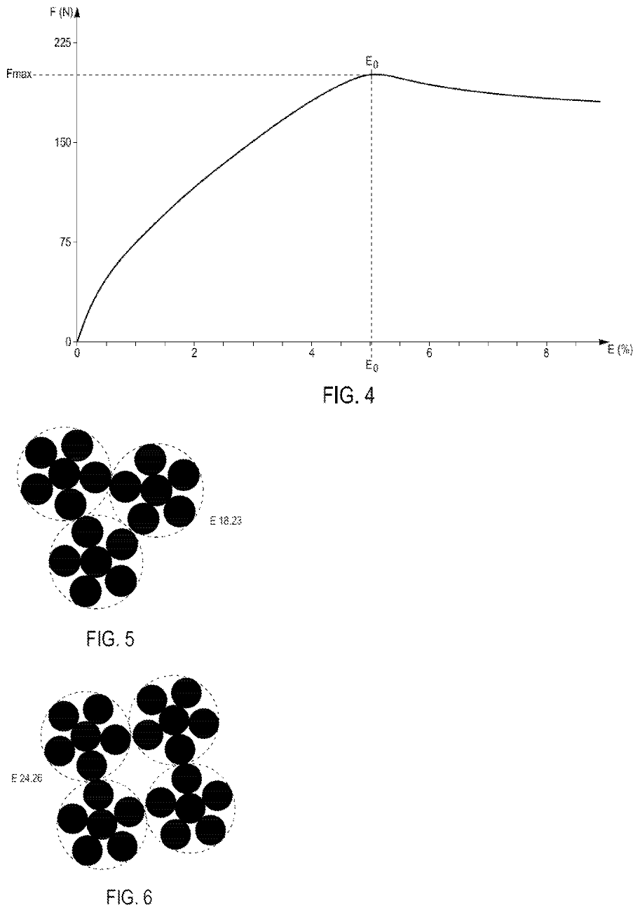

FIG. 4: Typical example of a compressive force-compressive strain curve for an elastic metal reinforcer according to the invention, obtained on a test specimen made of elastomeric material

FIGS. 5 and 6: Assembly formulas for two particular examples of elastic metal reinforcer according to the invention (E18.23 and E24.26)

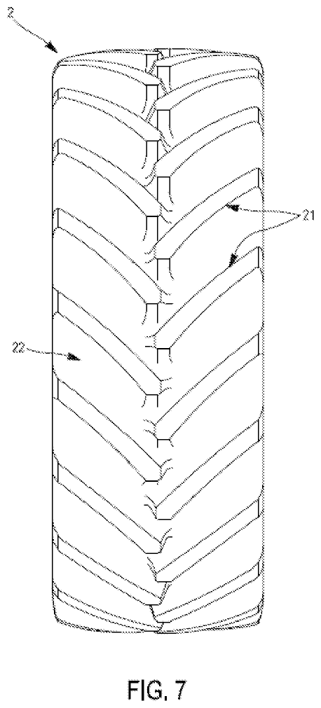

FIG. 7: Face-on view of a tire for an agricultural vehicle with lugged tread.

FIG. 1 shows a meridian half-section, on a meridian plane YZ, passing through the axis of rotation YY′ of the tire, of a tire 1 for an agricultural vehicle, comprising a crown reinforcement 3 radially on the inside of a tread 2 and radially on the outside of a carcass reinforcement 4. The crown reinforcement 3 comprises two crown layers (31, 32) each comprising metal reinforcers which are coated in an elastomeric material, are mutually parallel and form an angle A (not depicted) at least equal to 10° with a circumferential direction (XX′), The crown reinforcement 4 comprises three carcass layers comprising textile reinforcers that are coated in an elastomeric material, are mutually parallel and form an angle D (not depicted) at least equal to 85° and at most equal to 95° with the circumferential direction (XX′).

FIG. 2 is a typical example of a tensile force-relative elongation curve for an elastic metal reinforcer according to the invention, coated with an elastomeric material, showing its elastic behaviour under tension. The tensile force F is expressed in N and the elongation A is a relative elongation expressed as a %. According to the invention, the elastic and bi-modulus law governing the behaviour under tension comprises a first portion and a second portion. The first portion is delimited by two points of which the ordinate values correspond respectively to a zero tensile force and to a tensile force equal to 87 N, the respective abscissa values being the corresponding relative elongations (in %). A first tensile stiffness KG1 may be defined, this representing the gradient of the secant straight line passing through the origin of the frame of reference in which the behaviour law is represented, and the transition point marking the transition between the first and second portions. With the knowledge that, by definition, the tensile stiffness KG1 is equal to the product of the extension modulus MG1 times the cross-sectional area S of the reinforcer, the extension modulus MG1 can easily be deduced from it. The second portion is the collection of points corresponding to a tensile force greater than 87 N. Likewise, for this second portion, a second tensile stiffness KG2 may be defined, this representing the gradient of a straight line passing through two points positioned in a substantially linear part of the second portion. In the example depicted, the two points have the respective ordinate values F=285 N and F=385 N, these tensile force values corresponding to levels of mechanical loading indicative of the loadings applied to the metal reinforcers of the crown layers when the tire being studied is being driven on. As described previously, KG2=MG2*S, and so the extension modulus MG2 can be deduced therefrom.

FIG. 3 depicts two tensile stress-elongation curves, the tensile stress F/S, expressed in MPa, being equal to the ratio between the tensile force F, expressed in N, applied to the reinforcer, and the cross-sectional area S of the reinforcer, expressed in mm², and the elongation A being the relative elongation of the reinforcer, expressed in %. The cross-sectional area S of the reinforcer is the cross section of metal equal to ML/ρ, ML being the linear density of the reinforcer, expressed in g/m and ρ being the volumetric density of the reinforcer, expressed in g/cm3 (for example, the volumetric density ρ of brass-coated steel is equal to 7.77 g/cm³). These curves are the laws governing the respective tensile behaviours of two examples of multistrand elastic reinforcers E18.23 and E24.26 coated with an elastomeric material. The first and second extension moduli MG1 and MG2 can be deduced directly from these curves. According to the invention, for each of the behaviour laws depicted, the first extension modulus MG1 is at most equal to 30 GPa, and the second extension modulus MG2 is at least equal to 2 times the first extension modulus MG1.

FIG. 4 is a typical example of a compressive force-compressive strain curve for an elastic metal reinforcer according to the invention, showing its elastic behaviour under compression. The compressive force F is expressed in N and the compressive strain is a relative compression, expressed as a %. This compression-behaviour law, determined on a test specimen made of elastomeric compound having a secant extension elastic modulus at 10% elongation, MA10, equal to 6 MPa, exhibits a maximum corresponding to the onset of buckling of the reinforcer. This maximum is reached for a maximum compression force Fmax, or critical buckling force, corresponding to a critical buckling strain E0. Beyond the point of buckling, the compressive force applied decreases while the strain continues to increase. According to the invention, the critical buckling strain E0 is at least equal to 3%.

FIGS. 5 and 6 show two examples of structures of multistrand elastic reinforcer assemblies, which are particular embodiments of the invention. FIG. 5 depicts a multistrand rope of E18.23 type, having a 3*(1+5)*0.23 structure, namely comprising a single layer of 3 strands, each strand comprising an internal layer of 1 internal thread wound in a helix and an external layer of 5 external threads wound in a helix around the internal layer. Each thread is made of steel and has an individual diameter equal to 0.23 mm FIG. 6 depicts a multistrand rope of E24.26 type, having a 4*(1+5)*0.26 structure, namely comprising a single layer of 4 strands, each strand comprising an internal layer of 1 internal thread wound in a helix and an external layer of 5 external threads wound in a helix around the internal layer. Each thread is made of steel and has an individual diameter equal to 0.26 mm These cords are obtained by twisting.

FIG. 7 depicts a face-on view of a tire for an agricultural vehicle with lugged tread. The tire 1 comprises a tread 2 made up of a first and a second row of lugs 21 extending radially outwards from a bearing surface 22 and disposed in a chevron pattern with respect to the equatorial plane of the tire. As described previously, when driven on, this type of tread generates cyclic compressive/tensile loadings of the metal reinforcers of the crown layers, which elastic reinforcers according to the invention, which have a large elongation under tension with a low modulus and a high critical buckling strain, are better able to withstand.

The invention has been implemented more particularly for an agricultural tire of size 600/70R30 comprising a crown reinforcement with two crown layers with elastic metal reinforcers of formula E18.23 or E24.26.

The geometric and mechanical characteristics of the two examples of elastic metal reinforcers studied are summarized in Table 1 below:

TABLE 1

| Type of metal | Multistrand rope | | Multistrand rope | |
|---|---|---|---|---|
| reinforcer | E18.23 | | E24.26 | |
| First extension | 21 | GPa | 17 | GPa |
| modulus MG1 | | | | |
| Second extension | 67 | GPa | 50 | GPa |
| modulus MG2 | | | | |
| Ratio MG2/MG1 | 3.2 | | 2.9 | |
| Critical buckling | 4.5% | | 4.4% | |
| strain E0 (%) | | | | |
| Linear density of the | 6.4 | g/m | 10.7 | g/m |
| reinforcer (g/m) | | | | |
| Reinforcer diameter D | 1.46 | mm | 1.92 | mm |
| (mm) | | | | |
| Strand diameter DT | 0.70 | mm | 0.80 | mm |
| (mm) | | | | |
| Strand helix angle AT | 24° | | 25.5° | |
| (°) | | | | |
| Strand helix pitch PT | 8 | mm | 6 | mm |
| (°) | | | | |

| | | |
|---|---|---|
| Crown layer breaking | 616 N/mm (P = 2.5 mm) | 781 N/mm (P = 3 mm) |
| strength R (N/mm) for | | |
| a reinforcer pitch | | |
| spacing P in mm | | |

The inventors tested the invention by comparing the life, from a crown reinforcement endurance viewpoint, of a tire of size 600/70R30, comprising two crown layers with elastic metal reinforcers according to the invention, with that of a reference tire, comprising six crown layers with textile reinforcers. Each tire, inflated to a pressure P equal to 50 kPa and subjected to a load Z equal to 2600 daN was run, on an asphalted surface, under torque, with an applied circumferential loading F_{X} equal to 520 daN and at a speed V equal to 27 km/h.

1. A fire for an agricultural vehicle, comprising:
a crown reinforcement, radially on the inside of a tread and radially on the outside of a carcass reinforcement,
the crown reinforcement comprising at least two crown layers each comprising metal reinforcers which are coated in an elastomeric material, are mutually parallel and form an angle A at least equal to 10° with a circumferential direction (XX′),
wherein any metal reinforcer of a crown layer has a law, known as a bi-modulus law, governing its elastic behaviour under tension, and comprising a first portion having a first extension modulus MG1 at most equal to 30 GPa, and a second portion having a second extension modulus MG2 at least equal to 2 times the first extension modulus MG1, said law governing the tensile behaviour being determined for a metal reinforcer coated in an elastomer compound having a tensile elastic modulus at 10% elongation, MA10, at least equal to 5 MPa and at most equal to 15 MPa, and wherein any metal reinforcer of a crown layer has a law governing its behaviour under compression that is characterized by a critical buckling strain EU at least equal to 3%, said law governing behaviour under compression being determined on a test specimen made up of a reinforcer placed at its centre and coated with a parallelepipedal volume of an elastomer compound having a tensile elastic modulus at 10% elongation, MA10, at least equal to 5 MPa and at most equal to 15 MPa.

2. The tire according to claim 1, wherein the crown reinforcement is made up of two crown layers and any metal reinforcer of a crown layer (31, 32) has a linear density, expressed in g/m, wherein the linear density of a metal reinforcer of a crown layer is at least equal to 6 g/m and at most equal to 13 g/m.

3. The tire according to claim 1, wherein any metal reinforcer of a crown layer is a multistrand rope of structure 1×N comprising a single layer of N strands of diameter DT wound in a helix at an angle AT and a radius of curvature RT, each strand comprising an internal layer of M internal threads wound in a helix and an external layer of P external threads wound in a helix around the internal layer.

4. The tire according to claim 3, wherein the helix angle AT of a strand is at least equal to 20° and at most equal to 30°.

5. The tire according to claim 3, wherein the crown reinforcement is made up of two crown layers and any metal reinforcer of a crown layer has a diameter D, wherein the diameter D of a metal reinforcer of a crown layer is at least equal to 1.4 mm and at most equal to 3 mm.

6. The tire according to claim 1, wherein the crown reinforcement is made up of two crown layers and a crown layer has a breaking strength R expressed in N/mm, wherein the breaking strength R of a crown layer is at least equal to 500 N/mm and at most equal to 1500 N/mm.

7. The tire according to claim 1, wherein the crown reinforcement comprises at least one hooping layer comprising reinforcers which are coated in an elastomeric material, are mutually parallel and form an angle B at most equal to 10° with the circumferential direction (XX′).

8. The tire according to claim 1, wherein the crown reinforcement comprises at least one additional crown layer comprising metal reinforcers which are coated in an elastomeric material, are mutually parallel and form an angle C at least equal to 60° and at most equal to 90° with the circumferential direction (XX′).

9. The tire according to claim 1, wherein the carcass reinforcement comprises at least one carcass layer comprising textile reinforcers which are coated in an elastomeric material, are mutually parallel and form an angle D at least equal to 85° and at most equal to 95° with the circumferential direction (XX′).

10. The tire according to claim 1, wherein the tread is made up of a first and a second row of lugs extending radially outwards from a bearing surface and disposed in a chevron pattern with respect to the equatorial plane (XZ) of the tire.
